(19) United States
(12) Patent Application Publication
(10) Pub. No.: US 2004/0188556 A1
(43) Pub. Date: Sep. 30, 2004

(54) Single cutter shredder

(76) Inventor: Tom Jong, SanChung City (TW)

Correspondence Address: DENNISON, SCHULTZ & DOUGHERTY, 612 Crystal Square 4, 1745 Jeffeson Davis Highway, Arlington, VA, 22202-3417, US

(21) Appl. No.: 10/395,198

(22) Filed: Mar. 25, 2003

(51) Int. Cl. B02C 18/16

(52) U.S. Cl. 241/243

(57) ABSTRACT

The present invention is a single cutter shredder, mainly comprises: cutter frame, holder, rotary cutter and feeding assembly. The single cutter shredder cut paper to be cut into countless paper chips to realize the object of cut paper by the shearing force between rotary cutter formed form a plurality of rotary cutters inserting into corresponding number of cutter slippers and the fixed cutter of holder.

### FILED OF THE INVENTION

The present invention relates to an improved structure of shredder, especially, is a single cutter shredder.

### BACKGROUND OF THE INVENTION

Shredder, just as its name implies, a machine that cut paper into chips by mechanical cutting, the more important object is to destroy the content on the paper and to keep security, besides to cut the paper into chips to decrease the quantity of the garbage to protect environment.

Shredder can be classed into two types, the stripe-cut shredders and cross-cut shredders, according to the machine cutting style. So-called strip-cut shredder, as shown in FIG. 1, U.S. Pat. No. 6,260,780, is coupled a plurality of cutting disks and spacers on the rotary cutter shaft, and use the shearing force that the two opposite rotary cutter shaft produce and transfer to paper to cut paper passed through in longitudinal direction into stripes. And the so-called cross-cut shredder, as shown in FIG. 2, U.S. Pat. No. 6,260,780, every cutter has more than one blade part, and cutter is disposed helically on the rotary cutter shaft to cut paper in latitudinal direction into strips and further cut paper in longitudinal direction into approximate 5 mm×40 mm paper chips.

We can learn from that the said strip-cut shredder or cross-cut shredder has rotary cutter shaft composed of a plurality of cutters or spacers, the cost of parts of cutters or spacers and the expenses of assemble by workers account for a considerable proportion on the cost of entire shredder. Additional, most of the cutters and spacers are moldings, the accumulative tolerance that formed from the add up of permitted tolerance of every parts arranged on cutter shaft will often results in the two opposite cutters can't be put in order and form assemble fault that must be adjusted specially to operate normally and is troublesome.

### SUMMARY OF THE INVENTION

The inventor think over an improved shredder that can overcome the disadvantages of said well-known shredder and create a single cutter shredder through longtime study and test.

The main object of the present invention is to provide a single cutter shredder, is set a plurality of rotary cutter into cutter sliders to form a single cutter, and use the shearing force that the rotary cutter and holder bring to paper to cut paper to be cut in latitudinal direction into countless paper chips to realize the object of cutting paper.

The second object of the present invention is to provide a single cutter shredder, is by the shearing force that the single cutter formed from few rotary cutter inserting into cutter sliders and fixed cutter bring to paper passing through to realize the object of cutting paper, omit completely the plurality of cutters and spacers of rotary cutter of well-known strip-cut shredder or cross-cut shredder to decrease the cost of parts and the relative expenses of assemble by workers.

The another object of the present invention is to provide a single cutter shredder that has no the problem of accumulative tolerance on assemble because omit completely the plurality of cutters and spacers of rotary cutter of well-known stripe-cut shredder or cross-cut shredder.

### BRIEF DESCRIPTION OF THE DRAWINGS

FIG. 1 is a well-known strip-cut shredder disclosed by U.S. Pat. No. 6,113,017;

FIG. 2 is a well-known cross-cut shredder disclosed by U.S. Pat. No. 6,260,780;

FIG. 3 is a perspective of outline of the present invention;

FIG. 4 is a combined sectional view of holder taken on the line of 4-4 in FIG. 3;

FIG. 5 is a combined perspective view of the present invention;

FIG. 6 is a combined sectional view taken on the line 6-6 in FIG. 3;

FIG. 7 shows the operation of feeding and cutting of the present invention.

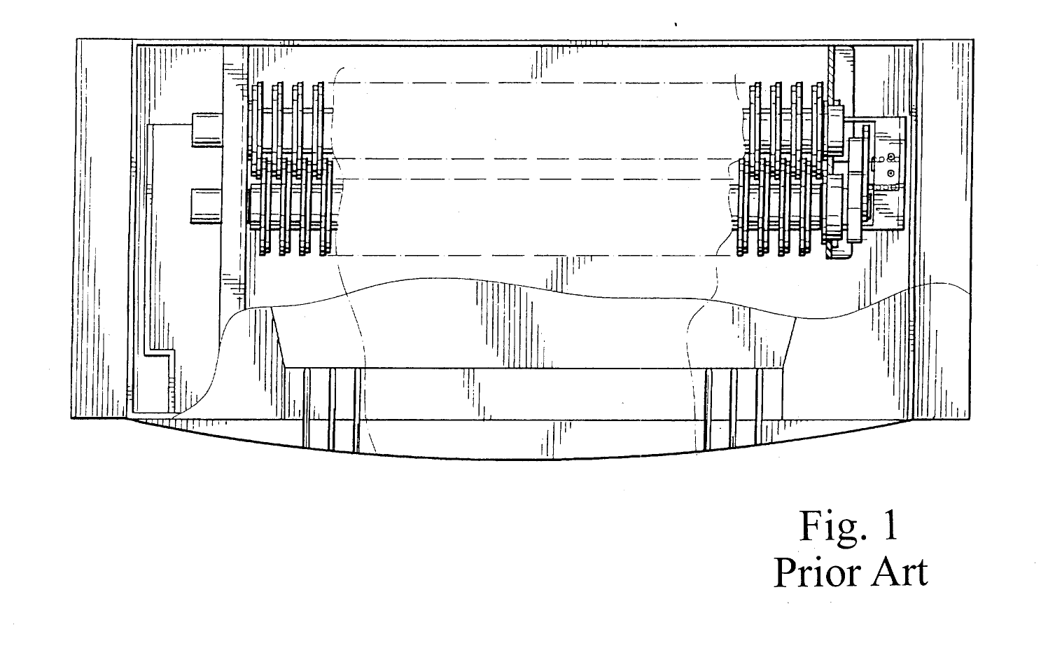

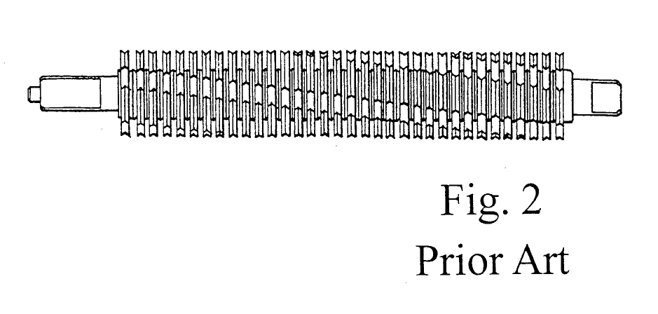

### DESCRIPTION OF THE PREFERRED EMBODIMENT

The present invention will be described in detail hereinafter, with reference to accompanying drawings.

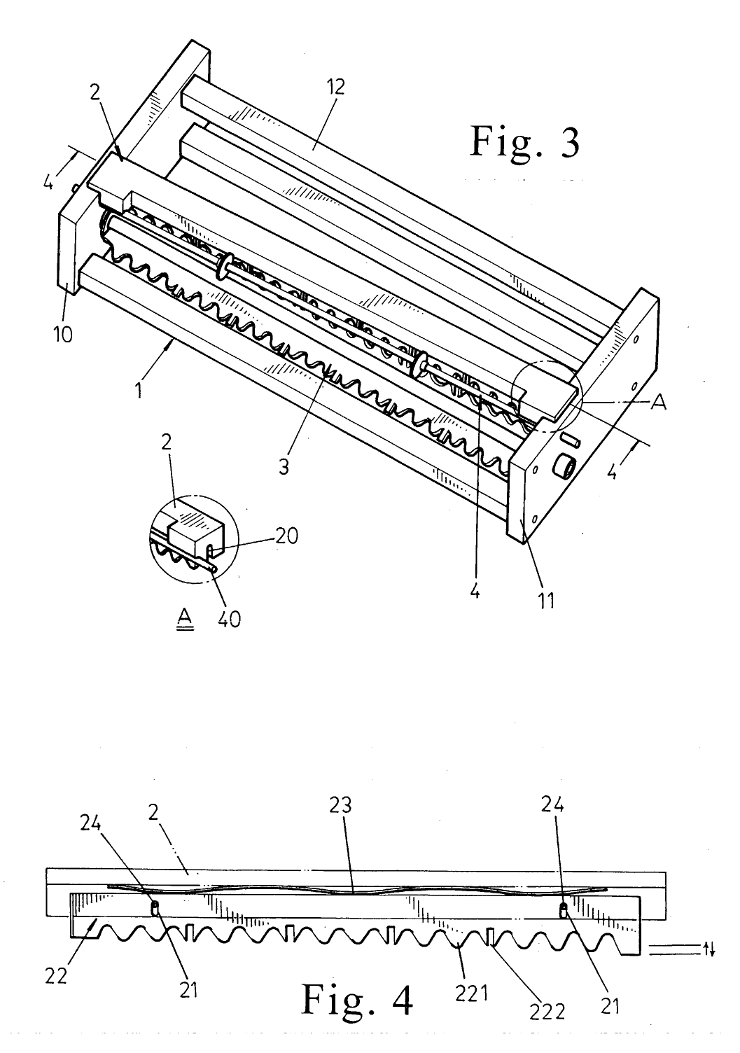

Please refers to FIG. 3 through FIG. 6, the present invention mainly comprises: cutter frame 1, holder 2, rotary cutter 3 and feeding assembly 4, wherein,

Cutter frame 1 includes left, right end plates 10,11, and has some latitudinal spacing rods for supporting and bearing the weigh of relative members.

Holder 2 bestrides on the left, right cutter frame 10,11 and has straight groove 20 (as shown in view A) on the bottom for fixed cutter 22 having a sine wave continuous mold 221 and spaced cutting mold 222 inserting into, fixed cutter 22 has locating long holes 21 on the two sides (as shown in FIG. 4), when fixed cutter 22 be inserted into straight groove 20, the fixed cutter 22 will be located on holder 2 by fixed pin 24 through said locating long holes 21. A wave spring 23 is set in the straight groove 20 of holder 21 and disposed upon the fixed cutter 22, the spring 21 bring downward compression to fixed cutter 22 to enable fixed cutter 21 move up and down in the region of locating long holes 21.

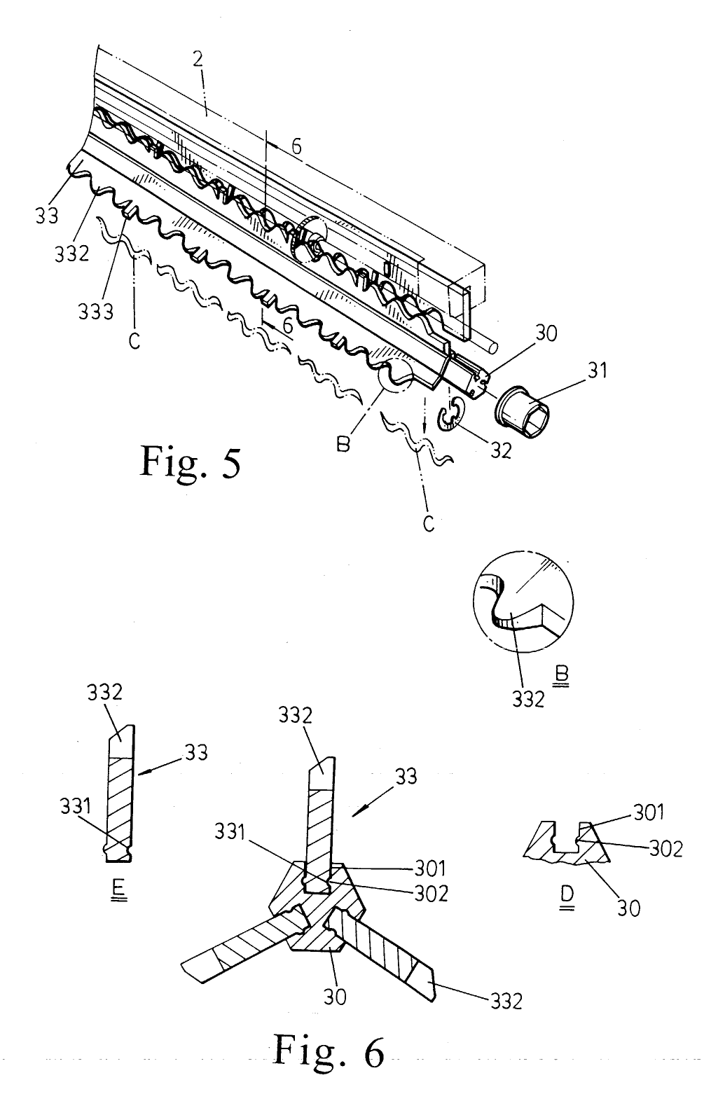

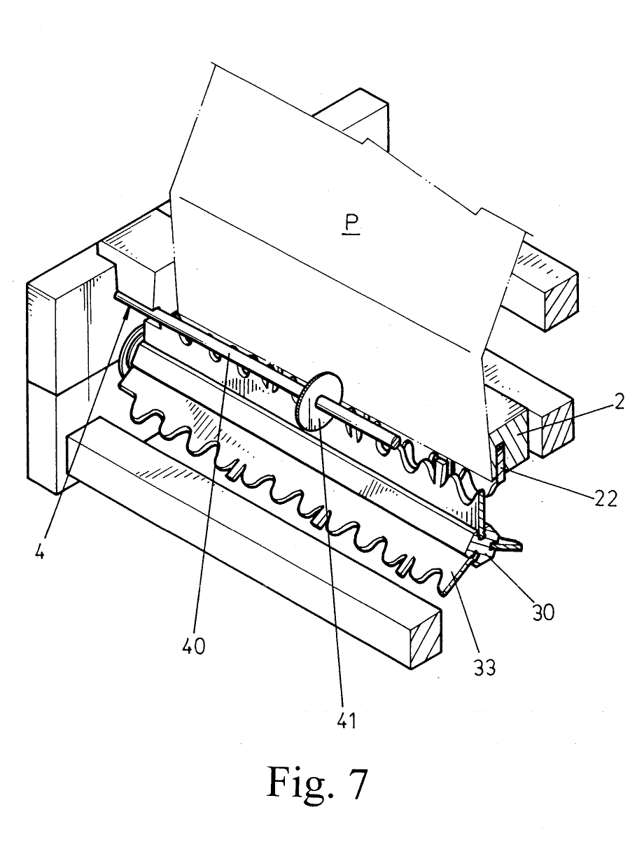

Please refers to FIG. 5, FIG. 6, view B, view D and view E, rotary cutter 3 includes hexagonal cutter shaft 30, bushing 31, E ring 32 and a plurality of rotary cutters 33. The two ends of said hexagonal cutter shaft 30 are fixed on left, right end plates 10,11 and are driven by well-known drive mechanism to rotate. Cutter shaft 30 has some sliders 301 equally spaced around the perimeter, slider 301 has cooer tail groove 302 for preventing cutter shaft 30 falling out. Corresponding to cutter shaft 30, after the cooer tail part 331 of rotary cutter 33 of sliders 301 inserting into sliders 301 of cutter shaft 30, the two ends of rotary cutter 33 will be fixed by E rings 32 and be located on cutter shaft 30 and will no move along axis and radial direction. The rotary shaft 33 has sine continuous blades 332 and spaced cutters 33 corresponding to the sine continuous mold 221 and spaced cutting mold 222 of fixed cutter 22.

Please refer to FIG. 7, feeding assembly 4 for feeding paper downward is disposed upon rotary cutter 33 and on the out side of holder 2 and has rotary shaft 40 coupled on left, right cutter frame 10,11 and at least two feeding rollers 41 with sharp teeth fixed on rotary shaft 40. When rotary shaft 40 be driven by well-known drive mechanism to rotate, the sharp teeth of feeding roller 41 has the effect of pricking the paper to be cut and pulling it downward for shredder.

The present invention, after assembled, by cutting act similarly scissors that between rotary 33 and fixed cutter 22 that give shearing force to cut paper to be cut in latitudinal direction, and corporate spaced cutter 333 and spaced cutting mold 222 to further cut paper strips that had been cut in latitudinal direction into paper chips C (as shown in FIG. 5) then realize the final object of cross-cut paper to be cut.

When said rotary cutter 33 and fixed cutter 22 cut paper to be cut with an act by shearing force, to avoid blade material loss that resulted from rigid material sudden impact, said wave spring 23 disposed upon fixed cutter 22 will act as a buffer, at the same time, the spring 23 bring continuously downward press to fixed cutter 22 to make the minimal clearance between fixed cutter 22 and rotary cutter 33 (the ideal clearance is zero), that is helpful to make cut act become more sharply and decrease the phenomena of raw edge of cut paper.

In the embodiment of the present invention, because the outline of rotary cutter and fixed cutter 22 is designed as continuous sine wave so paper to be cut will be cut into countless sine waved paper chips C. Of course, the outline of sine wave may be changed into square wave or V-shaped wave according to the market need and would not be confined with the shape disclosed by the embodiment.

To sum up, the present invention is set a plurality of rotary cutter into cutter sliders to form a single rotary cutter, and use the shearing force that the rotary cutter and holder bring to paper to cut paper to be cut in latitudinal direction into countless paper chips to realize the object of cutting paper. The present invention satisfies the criterion for novelty. The present invention is proposed according to related acts, it will be appreciated if this invention is granted patent right.

What is claimed is:

1. A single cutter shredder, comprising: cutter frame, holder, rotary cutter and feeding assembly, wherein:
cutter frame comprises left, right frame and some latitudinal spacing rods;
holder bestirred on said left, right cutter frame and has straight groove on the bottom for fixed cutter having sine wave continuous mold and spaced cutting mold inserting into, and has locating long holes on the left, right two sides, when fixed cutter insert into straight groove, fixed cutter be fixed on holder by fixed pin passing through said locating long hole, said holder has a wave spring in its straight groove and said wave spring disposed upon holders and enable fixed cutter move up and down in the region of locating long hole;
rotary cutter comprises rotary cutter shaft, bushing, ring and a plurality of rotary cutter, the two ends of said rotary cutter are coupled on said bushing and then fixed on left, right cutter frame, cutter shaft has some sliders spaced disposed on its perimeter, slider has cooer-tailed groove in its inertia for preventing cutter shaft form falling out; wherein, corresponding to cutter shaft, after the cooer tail part of rotary cutter of sliders inserting into sliders of cutter shaft, the two ends of rotary cutter will be fixed by E rings and be located on cutter shaft and will no move along axis and radial direction; wherein, said rotary shaft has sine continuous blades and spaced cutters corresponding to the sine continuous mold and spaced cutting mold of fixed cutter;
feeding assembly is disposed upon rotary cutter and on the outer side of holder, has rotary shaft coupled on left, right cutter frame and two feeding roller with sharp teeth.

2. The single cutter shredder according to claim 1, wherein the shape of continuous mold of holder is sine wave.

3. The single cutter shredder according to claim 1, wherein the shape of continuous mold of holder may be square wave, V-shaped wave or other proper shapes.

4. The single cutter shredder according to claim 1, wherein said rotary cutter has three sliders spaced 120 degree on the perimeter.
